(19) United States
(12) Patent Application Publication
(10) Pub. No.: US 2012/0043018 A1
(43) Pub. Date: Feb. 23, 2012

(54) PIPE INSULATION WITH FOAMED ADHESIVE CLOSURE

(76) Inventor: Paul Blair, Beelon (CA)

(21) Appl. No.: 13/284,347

(22) Filed: Oct. 28, 2011

Related U.S. Application Data
(62) Division of application No. 12/271,165, filed on Nov. 14, 2008.

(51) Int. Cl. B32B 37/26

(52) U.S. Cl. 156/289

(57) ABSTRACT

A pipe insulation product is provided including pipe insulation having an inside surface defining a central opening for surrounding a pipe, and a longitudinal slit defined by two opposing walls enabling the pipe insulation to be forced over a pipe to surround the pipe, a foamed adhesive layer applied to one or both of the opposing walls of the longitudinal slit, and one or more removable release strips for temporarily covering the foamed adhesive layers applied to one or both of the opposing walls of the longitudinal slit. The release strips protect the foamed adhesive layers prior to use, and the foamed adhesive layer provides for a closure with improved performance once the pipe insulation is applied to a pipe.

This is a divisional application of U.S. application Ser. No. 12/271,165 filed Nov. 14, 2008. The present invention relates to pipe insulation. The present invention more particularly relates to pipe insulation having a longitudinal slit therein for application over a pipe and an improved means for closing the slit once the insulation has been applied to a pipe.

### FIELD OF THE INVENTION

### Background of the Invention

Various approaches have been proposed for effecting the closure of pipe insulation by means of a closing tape attached to the pipe insulation adjacent a longitudinal cut in the pipe insulation.

For example, U.S. Pat. No. 4,584,217 teaches a solvent-based adhesive tape applied to pipe insulation to close the cut by bridging the pipe insulation on either side of the cut. The adhesive must overcome the tendency of a pipe located interior to the insulation to spread the cut.

Other arrangements have made use of an adhesive which adheres to the opposed faces of the cut, such that when the pipe insulation is pushed together to close the cut, the opposed faces adhesively engage and maintain the closed position.

The closure of pipe insulation is difficult, in that typically the pipe insulation is extruded using a foamed polyethylene type material, and thus the opposed faces of the cut comprise a cell structure and adhesion to these surfaces is somewhat difficult when a preformed adhesive layer is applied to the surface. A tape secured to the outer skin of the pipe insulation is also difficult to secure due to poor adhesion with the extruded skin of the article and ready exposure to the elements.

Moreover in some cases the prior art adhesives have been applied hot to the polyethylene foam insulation product, where the polyethylene has a lower melt temperature than the hot adhesive. Such prior art adhesives tend to deform the bonding surfaces, thus leading to poor bonding characteristics since the bond surfaces at the slits become deformed. Another problem is with respect to the ability to apply tape to the pipe insulation in an effective manner. The product, when initially extruded, is of a certain diameter and length, and for a period of at least about 24 hours after extrusion, the product will continue to shrink. Shrinkage is typically in the order of 2%. It has therefore been the practice to produce the pipe insulation by extrusion, cut or partially cut the material to form a longitudinal slit, cut the extruded product to length and thereafter store the material for a length of time sufficient to allow the product to shrink. After shrinkage has occurred, a closing tape is applied to the article adjacent the longitudinal slit. Unfortunately, this results in a two stage process with the tape being applied to the article only after the article has been stored for a certain period of time. It is certainly preferable to apply a tape when the pipe insulation is being produced, but application of the tape at this time will result in wrinkling of the tape, possible poor adhesion of the tape to the product, and the appearance of an inferior product.

U.S. Pat. No. 5,419,859 relates to a method of foaming pipe insulation with an adhesive closure which addressed the problems mentioned above. However, this patent teaches the use of hot melt pressure sensitive thermoplastic adhesive, which has somewhat limited adhesive properties when applied to extruded pipe insulation material.

U.S. Pat. No. 5,558,739 to Clark discloses an apparatus and method for applying adhesive to tape strips and then to the tubular insulation body. There is a length of tape feed path from glue head nozzles to the where it is applied to the insulation. Unfortunately, this length allows the glue on the surface of the tape to cool before being applied to the edges of the pipe insulation, and therefore optimal joining is not achieved.

In view of the foregoing, pipe insulation having an improved closure means once the insulation has been applied to a pipe is desirable.

### SUMMARY OF THE INVENTION

The present invention provides pipe insulation having a foamed adhesive closure. In particular, the present invention may be a pipe insulation product comprising: a straight, curved, or angled pipe insulation having an inside surface defining a central opening for surrounding a pipe, and a longitudinal slit defined by two opposing walls enabling the pipe insulation to be forced over a pipe to surround the pipe; a foamed adhesive layer applied to one or both of the opposing walls of the longitudinal slit; and one or more removable release strips for temporarily covering the foamed adhesive layers applied to one or both of the opposing walls of the longitudinal slit. The removable release strips temporarily protect the foamed adhesive layers, and the foamed adhesive layers enable the resilient closure of the longitudinal slit. A related method of manufacturing the pipe insulation is also provided.

The use of foamed adhesive with generally thick walled and large celled pipe insulation products realizes a number of advantages compared to unfoamed adhesives used, including: foamed adhesive yields a stronger bond with improved performance and has been demonstrated to reduce or eliminate cohesive failure under normal conditions; foamed adhesive generally cools quickly which entails a lower temperature during application, minimizing damage to opposing walls of the pipe insulation and allows for the use of lower melt index adhesives; the volume of foamed adhesive exhibits a “fill in” effect reducing the impact crevasses, cupping, etc., of the opposing walls providing improved bonding; improved adhesive performance of the foamed adhesive also generally requires less pressure during product installation, and introduction of tackifier agents can be included to further improve performance at lower ambient temperatures; and foamed adhesive has improved insulation properties.

### BRIEF DESCRIPTION OF THE DRAWINGS

A detailed description of the preferred embodiment(s) is(are) provided herein below by way of example only and with reference to the following drawings, in which:

FIG. 1A is an end perspective view of pipe insulation having a longitudinal slit;

FIG. 1B is an end perspective view of the pipe insulation having the longitudinal slit separated to reveal opposing walls;

FIG. 2 is a sectional view of the pipe insulation including foamed adhesive layers and release strips;

FIG. 3 is a partial perspective view showing an embodiment for making pipe insulation having a foamed adhesive closure;

FIG. 4 is a sectional view showing the application of foamed adhesive to opposing walls of the pipe insulation; and

FIG. 5 is a plot of creep displacement versus time for failure testing of pipe insulation.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

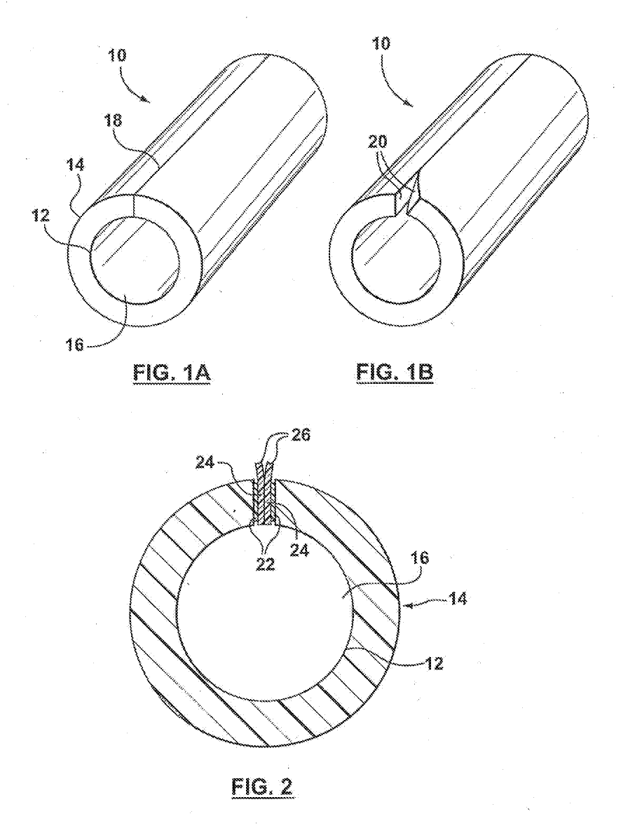

Foamed pipe insulation 10, preferably low density polyethylene pipe insulation, is well known and as illustrated in FIG. 1 is generally cylindrical in shape and comprises an inner wall or skin 12, an outer wall or skin 14, a hollow central opening 16, a longitudinal slit 18, and opposing walls 20 defined by the longitudinal slits 18. However other foamed thermo plastic materials can be used. Foamed pipe insulation 10 may be straight, curved, or angled, or consist of a combination of two or more of these characteristics.

The pipe insulation 10 between the inner walls 12 and the outer walls 14 is usually cellular. Typically these are closed cells or predominantly closed cells, however, it is possible to make pipe insulation with open cells or a large percentage of open cells, if so desired. In any event, the outer wall 14 is typically the skin of the extruded product and this outer skin can be difficult to adhere to for many adhesives. The longitudinal slit 18 is provided to enable the pipe insulation 10 to be resiliently joined after the pipe insulation 10 has been applied to a pipe. In other words, the slit 18 in the pipe insulation 10 allows access to the central opening 16 of the pipe insulation 10.

According to one particular aspect of the present invention, a foamed adhesive product can be implemented to effect the closure of the longitudinal slit 18 once the pipe insulation 10 has been applied to a pipe. As an example, the foamed adhesive can be a commercially available thermoplastic elastomer pressure sensitive adhesive product which may have a softening point of approximately 250 degrees Fahrenheit. More particularly, the foamed adhesive may incorporate block copolymer and/or amorphous poly-alpha-olefins technologies. The use of foamed adhesive for this application realizes many advantages for generally large diameter, thick walled and large celled pipe insulation products, as described more fully below.

As shown in FIG. 2, a preferred configuration for pipe insulation 10 is to provide foamed adhesive layers 22 on one or both sides of the opposing walls 20 and provide one or two release strips 24 to cover and protect the foamed adhesive layers 22. To ensure a maximum strength bond, it is preferable to have a foamed adhesive layer 22 and a release strip 24 for both sides of the opposing walls 20. The release strips 24 can be a 0.92 gauge low density or linear low density polyethylene strip coated with silicone on the side facing the foamed adhesive, for example.

The release strips 24 can include tab portions 26 extending beyond the periphery of the outer wall 14 of the pipe insulation to allow the user, after the pipe insulation 10 has been applied to a pipe, to remove the release strips 24 and then adhere the opposing walls 20 to one another thereby closing and maintaining the closure of the longitudinal slit 18.

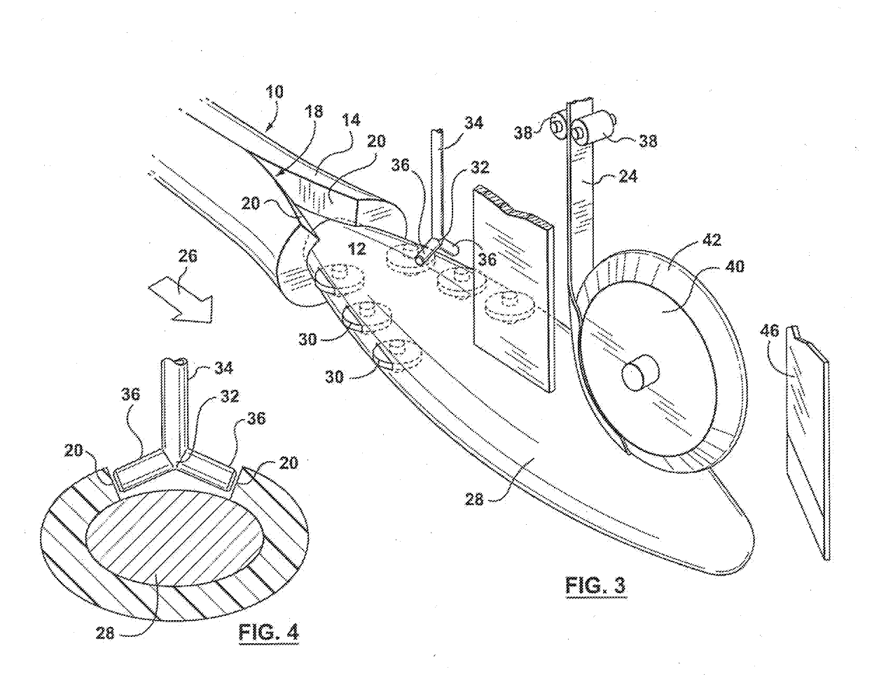

A method of manufacturing the pipe insulation 10 including the foamed adhesive layer 22 is provided in FIG. 3 and FIG. 4. The pipe insulation 10 is fed in direction 26 over a mandrel 28. The pipe insulation 10 is preferably of a polyethylene foam material which has just been extruded and cooled sufficiently to allow handling thereof. The pipe insulation 10 has already been cut to form the longitudinal slit 18 running the length of the insulation and forms the opposing walls 20. The pipe insulation 10 is guided over the mandrel 28 and the movement over the mandrel 28 is assisted, in this case by rotatable wheels or bearings generally shown as 30. Other arrangements are possible for allowing the pipe insulation to move over the mandrel to spread the opposing walls 20, as would be appreciated by a person of skill in the art. In this process the pipe insulation 10 is typically spread about 1 to 1.5 inches. The pipe insulation 10 is spread to expose the opposing walls 20 to the adhesive applicator head 32, which is connected to a foamed adhesive supply 34, and feeds the foamed adhesive to the nozzles 36. There may be a single or dual adhesive applicator head 32, feeding foamed adhesives to the nozzles 36 which may have a profile of any shape. Furthermore, the adhesive applicator head can be made to operate continuously or non-continuously so that the process of applying foamed adhesive may be run as a batch process.

A substantial layer of foamed adhesive is applied to one or both opposing walls 20 with the adhesive at a temperature ranging from about 175 to 375° F., and preferably ranging from about 175 to 230° F., or more particularly at a temperature as close to the melting point of the substrate as possible, for example 80 to 110° C., when it exits the nozzles 36. The temperature varies based on the softening point of the adhesive used. The foamed adhesive may be extruded or sprayed from the nozzles 36 onto the opposing walls 20. The direct, hot application of the foamed adhesive to the opposing walls 20 produces better adhesion than if an adhesive is applied cold or unfoamed to these surfaces. The pipe insulation may also still be warm from the extrusion process and a very strong bond between the wall section and the adhesive is achieved.

However, it should also be understood that a particular advantage of using foamed adhesive for this application is that the foamed adhesive product generally cools faster than the unfoamed adhesive product and therefore the foamed adhesive is generally at a lower temperature once it contacts the opposing walls 20 which acts to minimise damage to the opposing walls 20, and may allow use of lower melt index adhesives. This allows for use of adhesives with higher softening temperatures without damaging the pipe insulation walls. For example, the lower temperature application of the foamed adhesive product may significantly reduce “cupping” of the opposing walls 20 which is often seen with other adhesives. A cooler adhesive also reduces the possibility of damage to the release strips 24 upstream in the manufacturing process. As an example the actual temperature of the adhesive on contact varies based on the softening point of the adhesive used, and could range from 80 to 180° C.; typically 160° C.

It is believed that the expansion of the adhesive would cause cooling, however the foam could insulate further cooling. The initial cooling cause by the expansion would cool the adhesive and prevent melting of the foam but the heat retention ensures it has time to flow and bind to the foam. Also, the foaming agent lowers the viscosity of the melted foam ensuring good foam coverage.

Furthermore, the improved adhesive qualities of a foamed adhesive product enable the opposing walls to be optionally smoothed out to increase the surface contact areas and to increase the overall strength of the weld bond. Or, where smooth surfaces are not possible, for example, where there is cupping of the opposing walls 20 or crevasses inherent in the cellular structure, the volume of the foamed adhesive has a “fill-in” effect which bridges gaps between the opposing walls 20, such as crevasses and discontinuities, etc., and ensures a solid bond.

Moreover, the improved adhesive qualities of foamed adhesive generally require less pressure to achieve the bond during installation of the product, and, depending on the performance desired, less adhesive may be required as compared with unfoamed adhesives. The bond may be achieved when the density of the foamed adhesive is reduced by 1% to 70%. Preferably, the adhesive should be foamed such that its density is reduced by 40% to 50%.

Foamed adhesive also has improved insulation properties. In addition, improved performance of the foamed adhesive may allow for the introduction of tackifier agents (natural or synthetic substances that improve the initial and extended tack range of the adhesive, which also serve to reduce the required pressure to bond the adhesive to the product, reduce the required application temperature without use of a heat gun, reduce raw material costs as tackifiers act as a filler, and increase shelf-life of the adhesive) thereby improving performance at lower ambient temperatures. Tackifiers which are used for formulating pressure sensitive hot melts include hydrocarbon resins, esters, and process oils.

After the foamed adhesive has been applied, the pipe insulation 10 continues to move across the mandrel 28 for application of the release strip 24. This removable release strip 24 is preferably silicon coated, low strength polyethylene which can be elongated approximately 2% of its length by means of the drag of the film and tensioning rollers 38 to account for the shrinkage as the extruded pipe insulation 10 cools (as described more particularly in U.S. Pat. No. 5,419,859). The removable releasable strip 24 is brought into contact with the opposing walls 20 on the V wheel 40. The film is generally centered on the V edge 42 of the V wheel 40 and, at this point, the pipe insulation 10 is no longer being spread by the mandrel 28 and therefore the opposing walls 20 are forced into contact with the V edge 42, with the removable release strip 24 placed thereabout.

As illustrated in FIG. 2, the foamed adhesive may be applied only on approximately ¾ of the surface area of the opposing walls 20 and is not generally applied to the edge of these walls immediately adjacent the mandrel 28. This provides a small safety margin and it is preferable to fully coat these surfaces to provide effective securement thereof. However, the removable release strip 24 preferably penetrates sufficiently to fully cover the inside edge of the adhesive while also forming two releasable tabs, generally indicated as 26, projecting above the pipe insulation. At this point, the release strip 24 is in one piece covering both sides of the opposing walls and connected along a bottom edge. A knife 46 can be provided immediately downstream of the V wheel 40 to cut the removable release strip 24 to thereby form two removable release strips 24, one for each of the opposed walls 20. Alternatively, the release strips 24 can be applied separately to either side of the opposing walls 20, which may be more complicated but eliminates the need for a cutting step. Alternatively the foamed adhesive may be applied to the entire opposing walls 20.

To use the pipe insulation product, a user merely forces a pipe through the longitudinal slit 18, whereafter the release strips 24 are removed from each of the opposing walls 20 and these walls are brought into contact to effect adhesive securement therebetween. The removable release strips 24 with the tab portions 26 make it extremely convenient to remove these portions when the pipe insulation has been properly placed about a pipe.

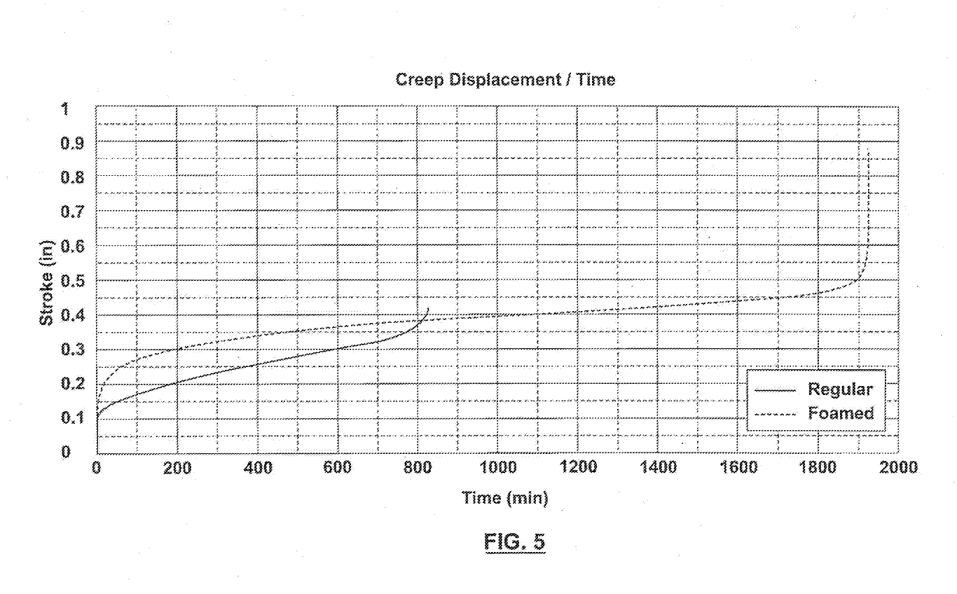

Failure testing has demonstrated that the use of foamed adhesive achieves a substantial improvement in performance as compared with unfoamed adhesives. In particular, tensile continuous displacement testing was conducting using ⅜″ wall thickness and 2″ length samples at 40° C. to test the strength of adhesive welds. The samples were prepared using the same adhesive for both the foamed and unfoamed adhesive samples. Samples were placed between two opposing hooks with the longitudinal slit oriented approximately midway and the hooks were pre-loaded with 22 lbs for 4 minutes. After a 0.05″ displacement from the set load, the hooks displaced the samples at a rate of 0.00250 inches per minute. As illustrated in FIG. 5, the foamed adhesive exhibited more than twice the performance of the unfoamed adhesive based on time to reach failure. Furthermore, unlike the unfoamed adhesive, foamed adhesive samples did not undergo cohesive failure.

The use of foamed adhesive with the foamed thermoplastic exhibited a number of advantages compared to unfoamed adhesives used, including:
1. The foamed adhesive yields a stronger bond with improved performance and has been demonstrated to reduce or eliminate cohesive failure under normal conditions. In other words the bond is less likely to separate on its own.
2. Foamed adhesive generally cools quickly which entails a lower temperature during application, minimizing damage to opposing walls of the pipe insulation and allows for the use of lower melt index adhesives. Cooler adhesives reduce release liner damage.
3. The application of hot adhesive can lead to “cupping” of the sides of the slits, ie the side surfaces of the slits become concave or convex thereby making it difficult to press the two side edges together to produce a good bond, as both sides will have a “memory” and tend to revert back to the original shape, causing separation of the bond. Use of cooler adhesives minimize “cupping” and promote good planar surface bonding.
4. The use of foamed adhesives minimizes wrinkling of the bonded surfaces, and therefore the slit surfaces can be smoothed out for increased surface contact area.
5. Since the slits have a better bond the foamed adhesive assists in the pipe insulation having better insulating properties.
6. The volume of foamed adhesive exhibits a “fill in” effect reducing the impact crevasses, cupping, etc., of the opposing walls providing improved bonding; improved adhesive performance of the foamed adhesive also generally requires less pressure during product installation, and introduction of tackifier agents can be included to further improve performance at lower ambient temperatures; and foamed adhesive has improved insulation properties.

Although various preferred embodiments of the present invention have been described herein in detail, it will be appreciated by those skilled in the art that variations may be made thereto without departing from the spirit of the invention or the scope of the appended claims.

What is claimed is:

1. A pipe insulation product comprising:
pipe insulation having an inside surface defining a central opening for surrounding a pipe, and a longitudinal slit defined by two opposing walls enabling the pipe insulation to be forced over a pipe to surround the pipe;
a foamed adhesive layer applied to one or both of the opposing walls of the longitudinal slit; and
one or more removable release strips for temporarily covering the foamed adhesive layers applied to one or both of the opposing walls of the longitudinal slit.

2. The pipe insulation product of claim 1 wherein the at least one foamed adhesive layer enables the resilient closure of the longitudinal slit.

3. The pipe insulation product of claim 2 wherein one of the foamed adhesive layers is applied to each of the opposing walls.

4. The pipe insulation product of claim 3 wherein one of the removable release strips is applied to each of the foamed adhesive layers for temporarily protecting the foamed adhesive layers.

5. The pipe insulation product of claim 1 wherein the at least one removable release strips include extended tab portions.

6. The pipe insulation product of claim 1 wherein the foamed adhesive is a thermoplastic elastomer pressure sensitive adhesive.

7. The pipe insulation product of claim 6 wherein the pipe insulation is extruded low density polyethylene.

8. A cylindrical pipe insulator product having two ends, an inside surface defining a central opening for surrounding a pipe, an outside surface, and a longitudinal slit defined by two opposing walls enabling the pipe insulation to be forced over a pipe to surround the pipe, wherein the improvement comprises the use of foamed adhesive applied to at least one of the opposing walls of the longitudinal slit for resilient closure of the longitudinal slit.

9. A cylindrical pipe insulator as claimed in claim 8 wherein said foamed adhesive comprises a foamed thermoplastic pressure sensitive adhesive.

10. A cylindrical pipe insulator as claimed in claim 8 wherein said foamed adhesive is foamed such that the density of the adhesive is reduced by an amount ranging from 1% to 70%.

11. A cylindrical pipe insulator as claimed in claim 10 wherein said foamed adhesive is foamed such that the density of the adhesive is reduced by an amount ranging from 40% to 50%.

12. A cylindrical pipe insulator as claimed in claim 9 wherein said insulator product comprises foamed polyethylene.

13. A cylindrical pipe insulator as claimed in claim 12 having a circular cross section.

14. A method of producing pipe insulation having a longitudinal slit with opposed walls of the pipe insulation located either side of the longitudinal slit, the pipe insulation including at least one foamed adhesive layer located for bonding the opposed walls and at least one removable release strip for temporarily protecting the foamed adhesive layer, the method comprising:
(a) extruding the pipe insulation;
(b) forming the longitudinal slit, the longitudinal slip enabling the pipe insulation to be forced over a pipe to sleeve the pipe;
(c) spreading the longitudinal slit to expose the opposed walls;
(d) applying the foamed adhesive layer to at least one of the exposed walls by spray means; and
(e) applying the removable release strip to each of the foamed adhesive layers.

15. A method as claimed in claim 14 wherein said method is continuous.

16. A method as claimed in claim 14 wherein said method is non-continuous.

17. A method as claimed in claim 14 wherein said extruded pipe insulation is cooled prior to forming the longitudinal slits.

18. A method as claimed in claim 17 wherein said adhesive is foamed by nitrogen gas

19. A method as claimed in claim 18 wherein said foamed adhesive is applied at a temperature to minimize cupping of said slits.
